(19) United States
(12) Patent Application Publication
(10) Pub. No.: US 2009/0100377 A1
(43) Pub. Date: Apr. 16, 2009

(54) METHOD FOR PROVIDING INFORMATION BY DATA PROCESSING DEVICE

(76) Inventors: Asako Miyamoto, Musashino (JP); Tsugumichi Owaki, Tokyo (JP); Takuya Akashi, Kokubunji (JP); Toshiyuki Tsutsui, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/250,937

(22) Filed: Oct. 14, 2008

(30) Foreign Application Priority Data
Oct. 16, 2007 (JP) 2007-268507

(51) Int. Cl. G06F 3/048

(52) U.S. Cl. 715/810

(57) ABSTRACT

It is possible to provide a service which can be easily customized in accordance with a user's preference. A method for providing information by a data processing device is applied to a data processing device which can acquire information from other information providing site via a network. In the state of display as a menu icon in a menu region on a desktop, no operation of menu is performed. In the state when the menu icon is dragged from the menu region to the desktop, it is possible to obtain operation of the menu as a Widget icon which displays the information acquired via the network.

### CLAIM OF PRIORITY

The present application claims priority from Japanese patent application JP 2007-268507 filed on Oct. 16, 2007, the content of which is hereby incorporated by reference into this application

### BACKGROUND OF THE INVENTION

The present invention relates to a method for providing information by a data processing device which can acquire information from other information providing site via a network and in particular to a method for displaying Widget which is a simple application for executing a particular function on a user terminal desktop.

Recently, much attention is paid on Widget which is a generic name of simple applications for executing particular functions on a desktop. The Widget is similar to Applet as a simple program. However, it is considered that the Widget has a common feature that the element of graphical interface (GUI) is strong as compared to the Applet. Various functions are provided as the Widget such as a calculator, news reader, schedule management, weather forecast, web camera image display, simple games, and stock price check. A plenty of Widgets have been developed for using a Web service which is online-provided in a desktop environment. The Widget began to attract attention at the end of 2005 and is now rapidly spread as a form of application.

As for a service such as a financial system provided via a network, a user should selects a particular service from a set service menu. Accordingly, when the user desires to receive a plurality of services, the user can record a service site but normally, the user cannot receive information from the site.

It is beneficial if it is possible to use the Widget in the use of various services of the financial system and the like. However, the Widget is normally started on a desktop and deleted if not necessary and downloaded when required.

### SUMMARY OF THE INVENTION

It is therefore an object of the present invention to provide a service which can easily be customized in accordance with a user's preference.

A method for providing information by a data processing device is applied to a data processing device which can acquire information from other information providing site via a network. In the state of display as a menu icon 130 in a menu region on a desktop 150, no operation of menu is performed. In the state when the menu icon is dragged from the menu region to the desktop, it is possible to obtain operation of menu as a Widget icon which displays the information acquired via the network.

According to the present invention, it is possible to display a necessary Widget as an arbitrary menu on a desktop and drag the necessary Widget from the menu to display it on the desk top or delete it. Thus, it is possible to provide a service which can easily be customized in accordance with a user's preference.

### BRIEF DESCRIPTION OF THE DRAWINGS

FIG. 1 is a diagram showing a system configuration of a financial information providing system.

FIG. 2 is a table showing a client channel management configuration of a banking institution host server.

FIG. 3 shows Widget data configuration.

FIG. 4 is a flow diagram for downloading the Widget.

FIG. 5 is screen transition diagram when downloading the Widget.

FIG. 6 is screen transition diagram when downloading the Widget.

FIG. 7 is an operation flowchart upon generation of a Widget icon 110.

FIG. 8 is an operation flowchart upon start of a user terminal.

FIG. 9 shows a screen of the desktop.

FIG. 10 is an operation flowchart of a view Widget.

FIG. 11 is an operation flowchart of a transaction Widget.

FIG. 12 shows a screen of the transaction Widget.

FIG. 13 is an operation flowchart upon generation of a Widget icon 110 according to another embodiment.

### DETAILED DESCRIPTION OF EMBODIMENTS

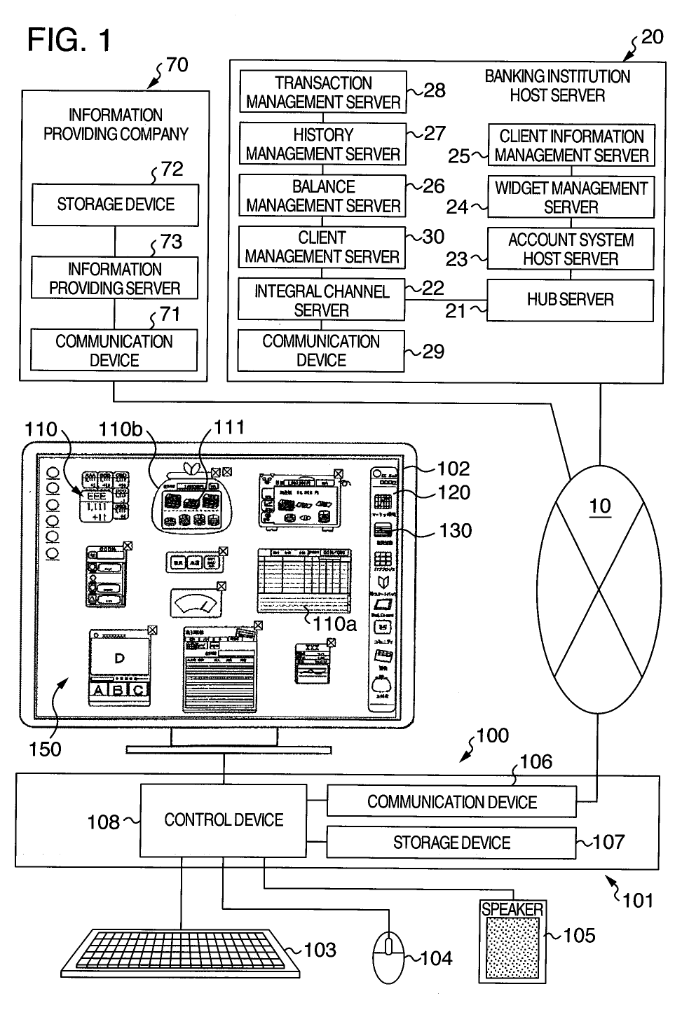

By referring to FIG. 1 to FIG. 13, specific explanation will be given on a Widget system according to the present embodiment. Hereinafter, a financial information providing system will be explained as an example. However, the present invention is not to be limited to the system but may be applied to an information providing/transaction system for providing various information and transaction services to a user terminal via a network by a particular service company solely or as a representative.

Firstly, referring to FIG. 1, explanation will be given on an outline of a financial information providing system using the Widget system. Here, FIG. 1 shows a system configuration of the financial information providing system.

In FIG. 1, the financial information providing system includes: a user terminal (data processing device) 100 which participates in the financial information providing system via a network 10; a banking institution host server 20 which provides various information to the user terminal 100; and an information providing company 70 which is linked with the banking institution host server 20 and provides various information to the user terminal 100. Here, in order to simplify the explanation, only one user terminal 100 and only one information providing company 70 are depicted. Actually, however, a plenty of them can participate. Moreover, only one banking institution host server 20 is depicted to simplify the explanation. However, the system may be formed by a plurality of branch systems and a plurality of host servers for managing them.

The user terminal may be an ordinary personal computer including a terminal body 101, a display device 102, a keyboard 103, a mouse 104, and a speaker 105. Here, the terminal body 101 is formed by a communication device 106 which can be connected to a network 10, a storage device 107 which can store various information and programs, and a control device 108 which performs overall control of the user terminal 100. FIG. 1 shows a desktop type personal computer. However, a laptop type personal computer or a mobile terminal can also participate in the financial information providing system.

Various devices (computers) of the banking institution host server 20 are connected via a HUB server 21 to a device (computer) of other branches (not depicted) and a device (computer) of a specialized center via a communication device 29 so as to perform the entire management of all the information in the banking institution. The HUB server 21 also serves as a gateway server and is connected to a Widget management server 24 which manages the Widget system, a client information management server 25 which integrally manages all the client information, and the like.

Moreover, an integral channel server 22 is a support system which is connected to a device (computer) of an branch office (not depicted) via the network 10 and provides various information to the device (computer) of the branch office. The integral channel server 22 is formed by a client management server 30 which manages a client use state, a balance managing server 26 which manages an account balance state, a history management server 27 which manages a client user history, and a transaction management server 28 which manages a client transaction state. In addition to this, the integral channel server 22 includes the following (not depicted): an IB server having IB content information, a branch office AP server having content information on the branch office, a client coming management server having coming client information, a commodity information server having commodity content information, and a bank staff management server having bank staff information.

The Widget system managed by the banking institution host server 20 as a main body is provided by the Widget management server 24 as a main body. The various services are provided by the Widget system by the Widget management server 24 which collects information from various servers constituting the banking institution host server 20 and provides the information to respective users via the Widget system. Besides that, the banking institution system may be connected to a device (computer) of other banking system and various service sites via the network 10.

Moreover, the information providing company 70 provides various information via a service site established on the network 10. The information providing company 70 includes a communication device 71 for connection to the network 10, a storage device 72 for storing various information, and an information providing server for integrally managing hardware resources constituting the information providing company 70. The information providing company 70 is defined as a destination of the information provided by the Widget system.

The Widget system is characterized in that various services provided by the system are prepared as a service menu for each of a specific service and provided in the Widget format to the user terminal 100. The Widget defined here is a simplified application for executing a particular function on the desktop 150 of the user terminal 100. The Widgets may be divided into two types: view Widgets 110a for viewing information provided by the information providing company 70 via the network 10 and transaction Widgets 110b which are connected to the Widget management server 24 and the like via the network 10 and enable various transactions.

These Widgets may be displayed as Widget icons 110 having an information display portion 111 on the desktop 150. The view Widget 110a can display information acquired periodically or when required, from the information providing company 70 on the information display unit 111. Moreover, the transaction Widget 110b can execute a transaction of information, securities, or money to/from other transaction window existing on the desktop 150 by drag.

Thus, by using the Widget system, it is possible to display necessary information on the desktop at any time via the Widget icon 110 without performing an operation for switching the display screen. It is also possible to execute a transaction with other Widget icon 110 by a simple drag operation.

Moreover, the Widget system has another significant characteristic that the Widget arbitrarily selected from the Widget management server 24 is displayed as a menu icon 130 on the Widget menu region 1120 arranged on the desktop 150. When the menu icon 130 displayed in the Widget menu region 120 is dragged onto the desktop 150, a Widget icon 110 is generated and the Widget icon 110 enters an operation state according to the generation. Moreover, when the Widget icon 110 is deleted from the desktop 150, it is possible to stop the operation of the Widget icon 110.

Thus, according to the Widget system, a user can create a favorite service in the Widget menu region 120. Accordingly, the user need not access the Widget management server 24 each time a service is received. The user can download the Widget all at once. Moreover, the Widget displayed in the Widget menu region 120 is not started by the download itself. That is, it is possible to set the Widget to a sleep state. The Widget in the sleep state can be set to an operation state by a simple operation, i.e., by dragging the menu icon 130 of the Widget menu region 120 onto the desktop 150. Moreover, by deleting the Widget icon 110 from the desktop 150, it is possible to set the Widget to the sleep state so that a large space on the desktop 150 can be used.

Moreover, the Widget system has still another significant characteristic that the Widget icon 110 generated on the desktop 150 is stored upon power turn OFF of the user terminal 100. When the power is turned ON, it is possible to perform a work in the same environment of the desktop 150.

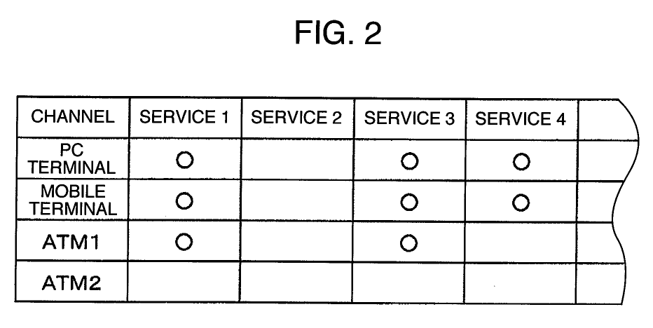

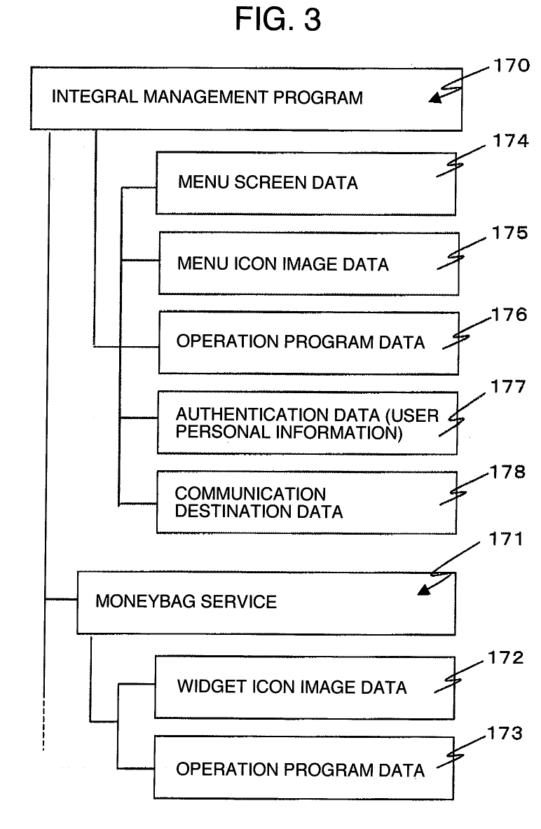

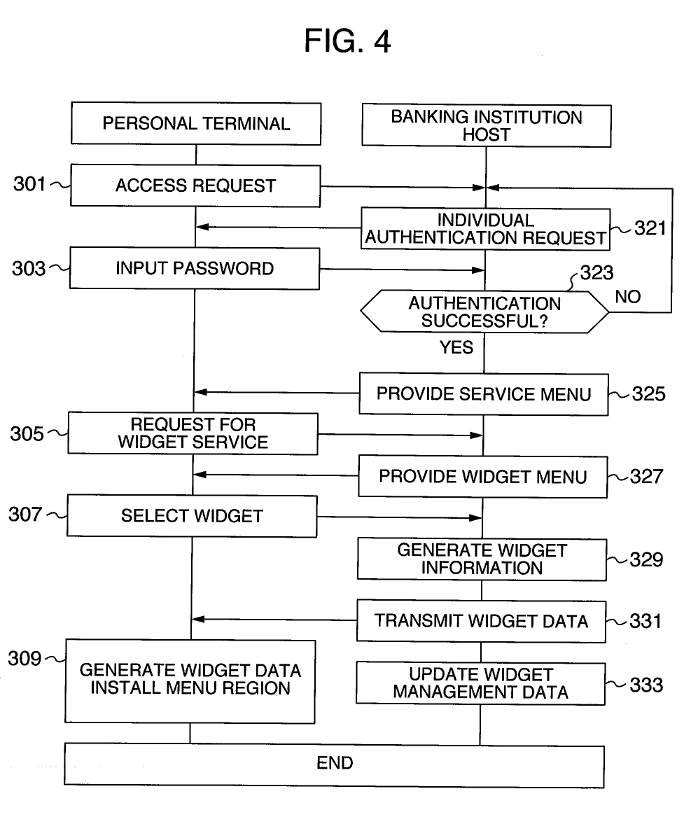

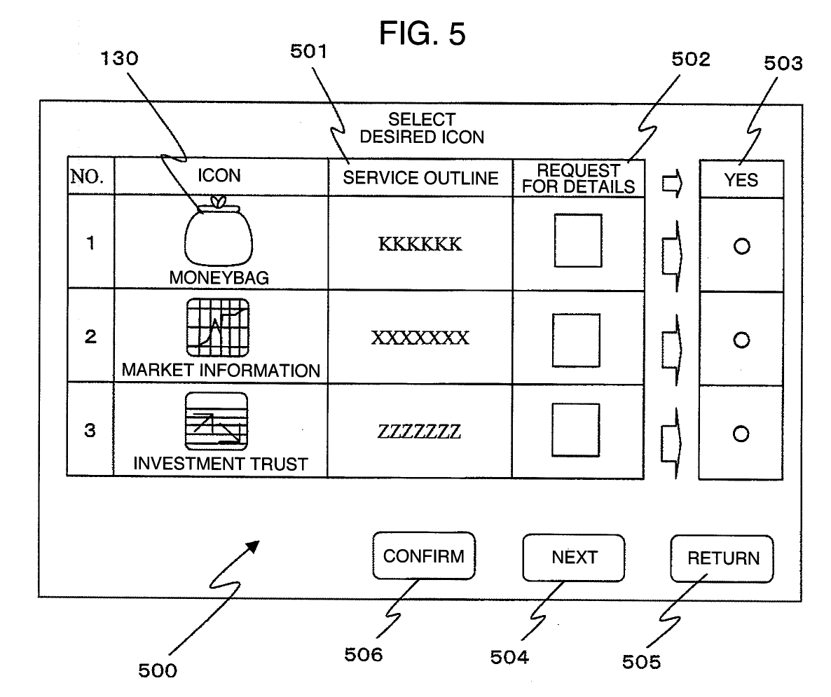

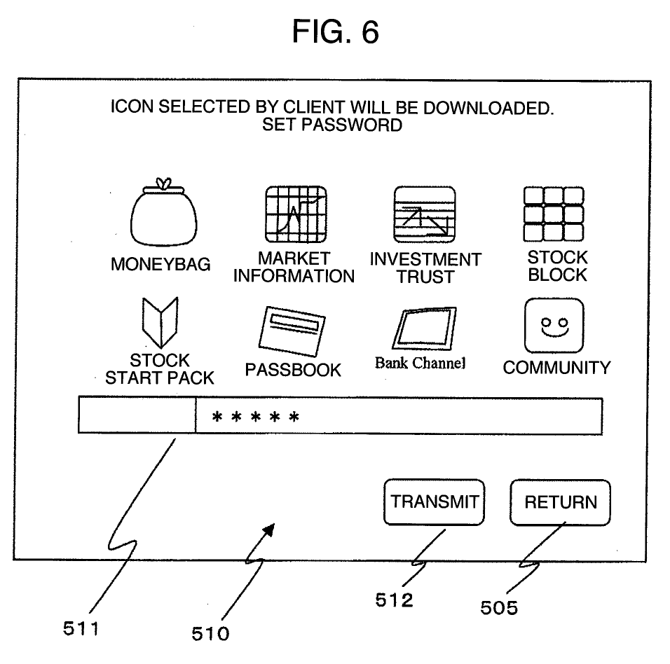

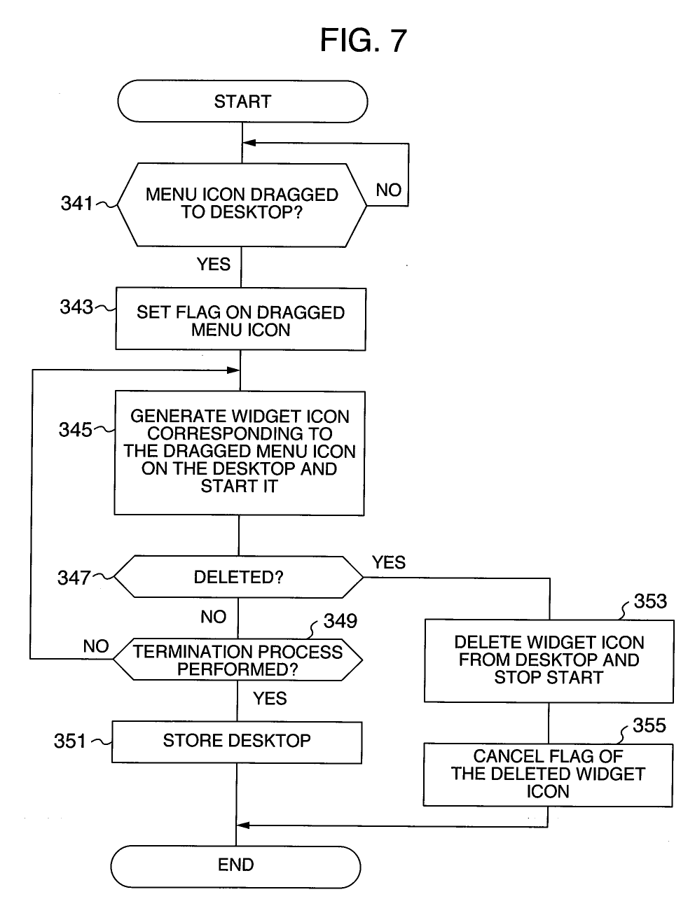

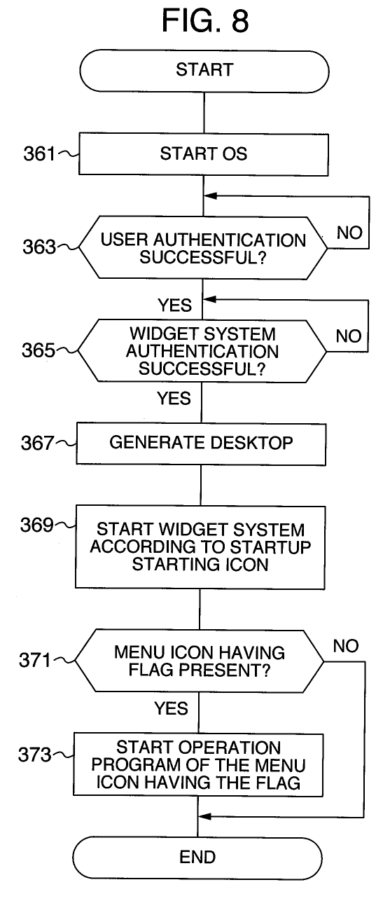

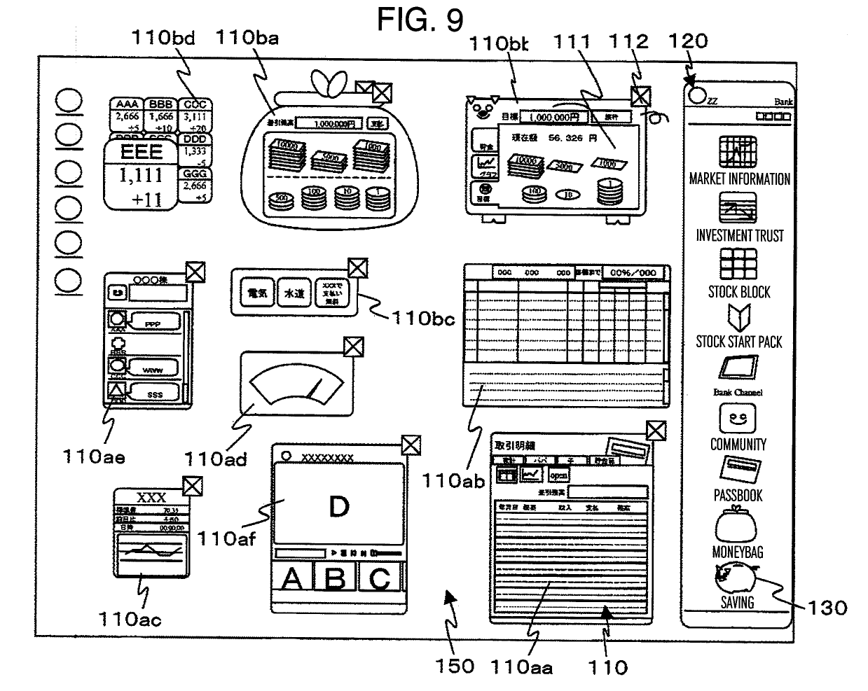

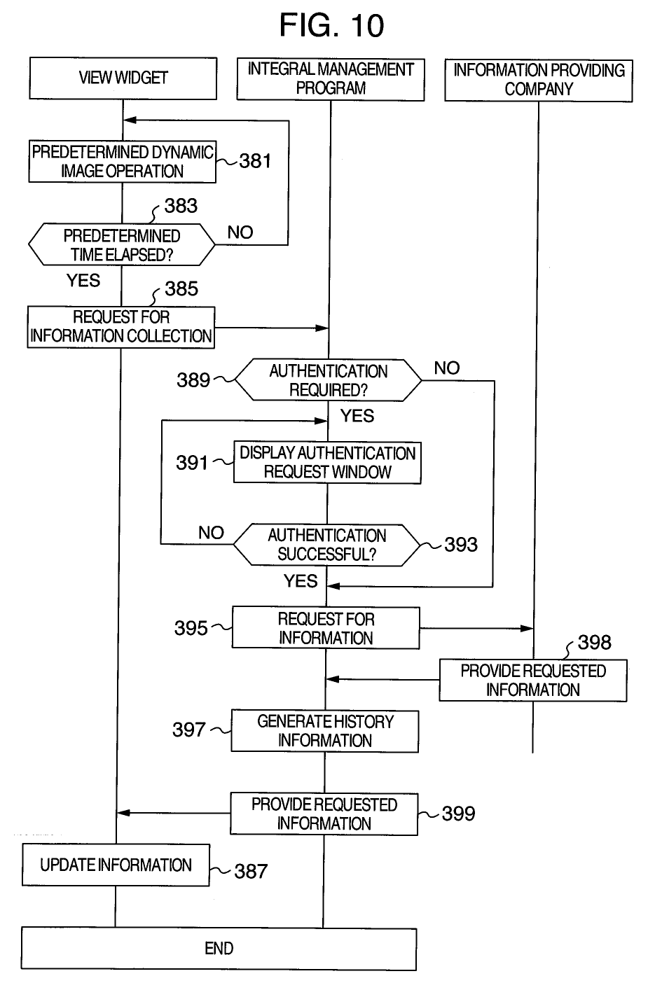

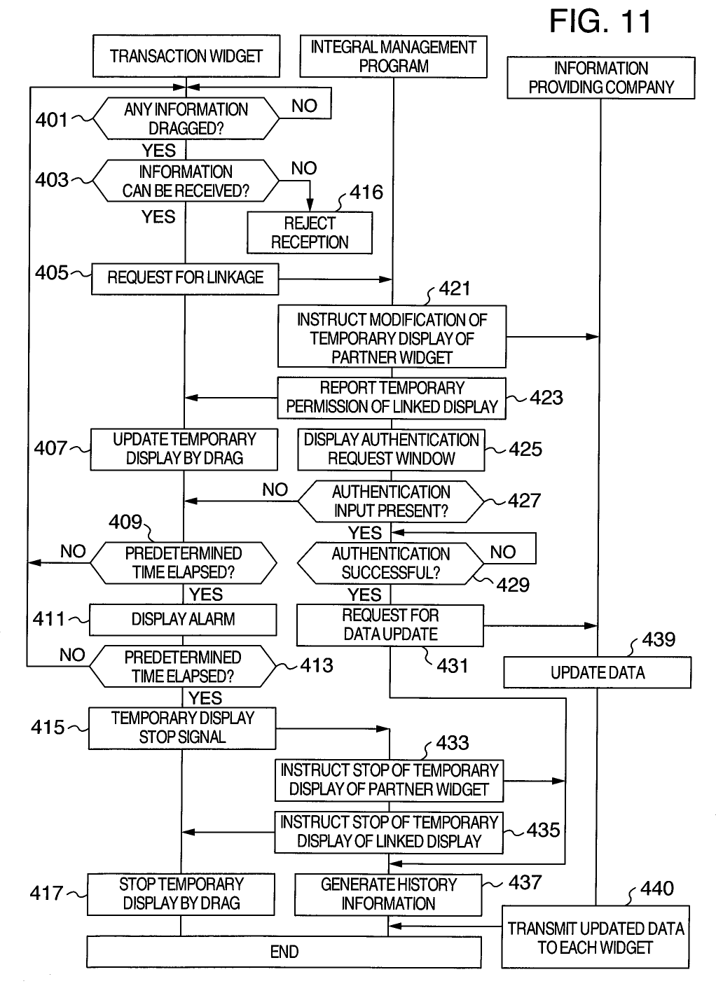

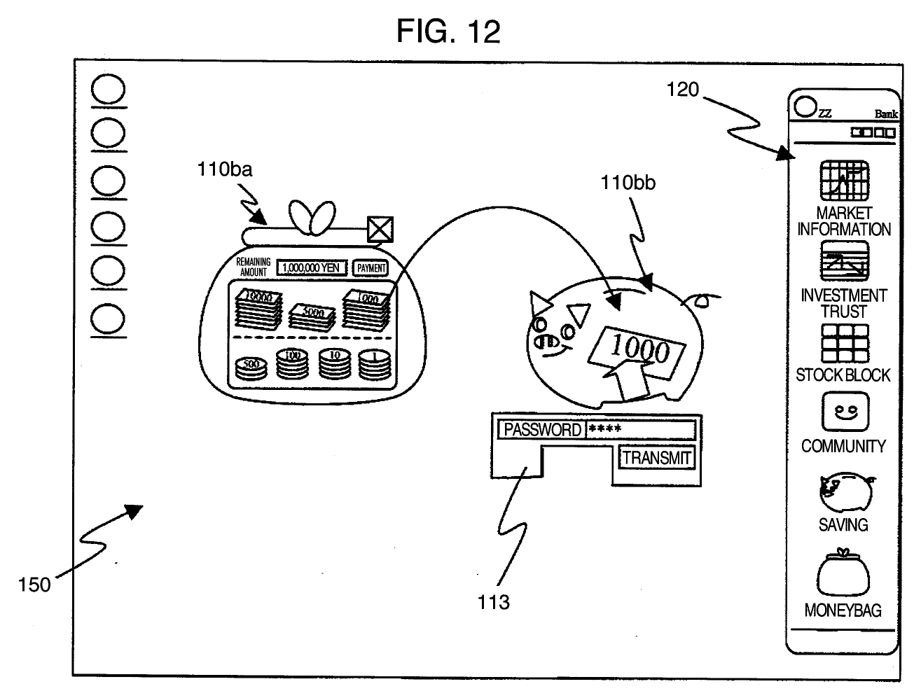

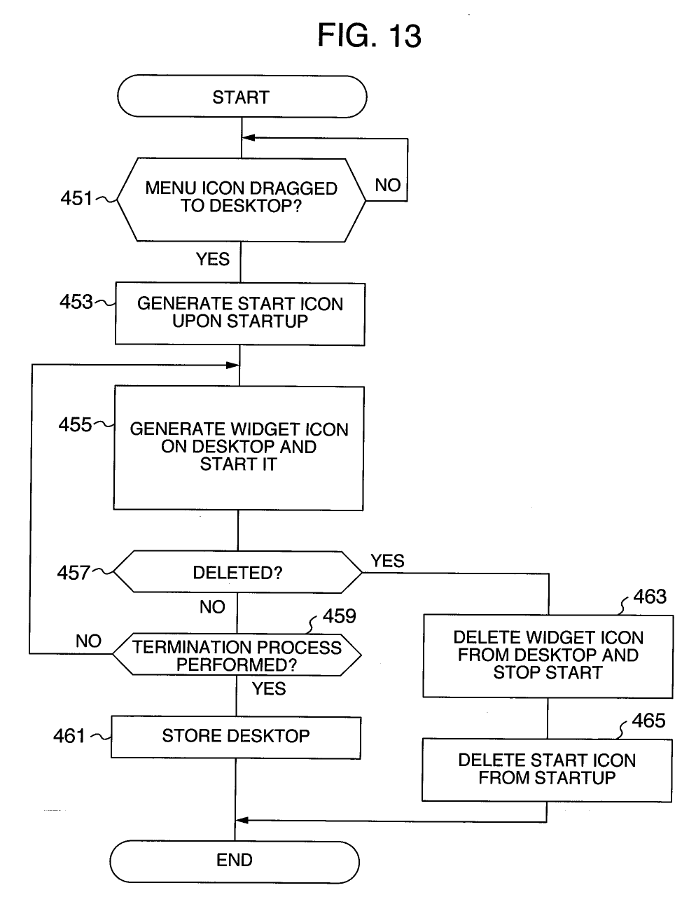

Hereinafter, referring to FIG. 2 to FIG. 13, the Widget system will be further detailed. Here, FIG. 2 is a diagram showing a configuration of a client channel management of a banking institution host server. FIG. 3 is a diagram showing a data configuration of the Widget. FIG. 4 is a flowchart for downloading the Widget. FIG. 5 and FIG. 6 are screen transition diagrams upon download of the Widget. FIG. 7 is an operation flowchart upon generation of a Widget icon 110. FIG. 8 is an operation flowchart upon start of a user terminal. FIG. 9 shows a screen of the desktop. FIG. 10 is an operation flowchart of a view Widget. FIG. 11 an operation flowchart of a transaction Widget. FIG. 12 shows a screen of the transaction Widget. FIG. 13 is an operation flowchart upon generation of a Widget icon 110 according to another embodiment.

Firstly, referring to FIG. 2, explanation will be given on a service provided by a banking institution host server 20. In FIG. 2, the banking institution host server 20 according to the present embodiment provides customized services based on the user preference to various channel (hardware resources) via the Widget management server 24. FIG. 2 shows a systematic configuration of the services. The Widget management server 24 can provide various services for a user terminal 100 defined as a PC terminal to a mobile terminal and an ATM (automatic teller machine) installed in a backing institution and the like. That is, the user can receive the same service even if the channel is changed.

Since the service received by the user is registered and managed by the Widget management server 24 as shown in FIG. 2, the user can also receive the same service via other channel. The display screen of the channel serving as a contact between the user and the Widget management server 24 has a different size and a different operation method depending on the channel and cannot be identical. Accordingly, the Widget management server 24 prepares different Widgets for one service according to respective channels. In the explanation given below, a PC terminal (user terminal 100) can display the desktop 150. However, the same type of service to be customized according to the user preference can also be received via other channel. Here, a detailed explanation is omitted.

Next, referring to FIG. 3 explanation will be given on the configuration of the Widget data. As shown in FIG. 3, the Widget management server 24 prepares Widget data 171 set for each of services and an integral management program 170 for integrally managing the Widget data 171. The Widget data 171 is formed by image data 172 of the Widget icon 110 set for each of the Widget data and an operation program 173.

On the other hand, the integral management program 170 includes: menu image data 174 which generates a Widget menu region 120 of the desktop 150; image data 175 of the menu icon 130 displayed in the menu image data 174 set for each Widget; an operation program 176 which integrally controls the Widgets in the user terminal 100; user individual authentication data; and communication destination data 178 set for each Widget. Here, the communication destination data 178 is not to be limited to one position but a plurality of communication partners may be set.

In this Widget system, when the user accesses the Widget management server 24 and selects an arbitrary Widget, it is possible to download the Widget data 171 corresponding to the selected Widget 171 and an integral management program 170 for managing the one or more Widget data 171 to the user terminal 100.

Next, referring the diagrams of FIG. 5 and FIG. 6, explanation will be given on the operation flow of the download based on FIG. 4. It should be noted that the explanation will be given on the operation of the Widget management server 24 as the operation of the banking institution host server 20.

In FIG. 4, when an access request is made from the user terminal 100 to the banking institution host server 20 via the network 10 (step 201), the banking institution host server 20 transmits screen data requesting for an input of a password and a member number so as to request the individual terminal 100 to perform an individual authentication (step 221). When the user terminal 100 inputs the password and the like (step 203), the banking institution host server 20 references the client management server 30 to decide whether the authentication is successful (step 223).

In the financial information providing system according to the embodiment, a client having an account in the banking institution can participate as a user. That is, the authentication of step 223 is performed by the same procedure as the authentication accompanying the opening of the account. When the authentication is successful, the banking institution host server 20 transmits screen data on the service menu to the user terminal 100 (step 325). If the user terminal 100 makes a request for the Widget service (step 205), the screen data on the Widget menu shown in FIG. 5 is transmitted to the user terminal (step 327).

In FIG. 5, the user terminal 100 can select a desired Widget via the Widget menu 500 displayed on the display device 102. The Widget menu includes a menu icon 130 for identifying the Widget, a service outline 501, a detailed request button 502, and a desire presence/absence selection column 503 which are arranged in a list. The user marks the desired Widget in a reply column 503 by referencing the service outline 501 or the explanation in the sub-window (not depicted) displayed according to the operation of the detailed request button. In the Widget menu, it is possible to advance to the next step by a proceed-to-next button 504 or return to a preceding step by a return button 505 or confirm the Widget to be requested by a confirm button 506.

FIG. 6 shows a state set when the confirm button 506 is pressed. In this embodiment, in response to the operation on the Widget menu 500, the banking institution host server 20 sends corresponding screen data to the user terminal 100. When the confirm button 506 is operated, the banking institution host server 20 sends the confirm screen 510 shown in FIG. 6. In the confirm screen 510, the Widget menu icons 130 selected by the user are presented at the top and a password input column 511 is arranged. When the user inputs the password into the input column 511 and operates a transmit button 512, the Widget selection operation is complete (step 207). It should be noted that detailed explanation on the Widget selection operation is omitted.

Upon reception of the Widget selection, the banking institution host server 20 generates the Widget management data shown in FIG. 2 in the Widget management server 24 or in a storage device (not depicted) under control of the Widget management server 24 (step 329). The Widget management data builds data to be provided into the service region of each channel. For example, in the case of “moneybag service” which is one of the transaction Widgets 110b, the operation is linked with the user account for generating a balance and the like. Alternatively, in the case of the view Widget 110a, data which can be viewed is collected from other server and built or an address of the information providing company to be provided is set as a destination. These Widget management data are reflected in the integral management program 170 shown in FIG. 3 which is provided to the user terminal 100.

The banking institution host server 20 sends the Widget data generated in step 329 to the user terminal 100 (step 331) and stores the history in the history management server 26 (step 333).

The control device 108 of the user terminal which has received the Widget data installs the Widget data. That is, the control device 108 writes the widget data into the program region, generates a start icon to start the operation program data 176 of the integral management program 170 in a start up menu, and generates a Widget menu region 120 on the desktop 150 according to the menu icon image data 175 (step 209).

Next, referring to FIG. 7, explanation will be given on the Widget start. In FIG. 7, the control device 108 of the user terminal 100 in which the Widget system is installed monitors whether the menu icon 130 of the Widget menu region is dragged to the desktop 150 (step 241). When the menu icon 130 is dragged to the desktop 150, a flag is set and stored for the Widget of the dragged menu icon 130 (step 243). Image data 172 for the Widget icon 110 corresponding to the dragged menu icon 130 is called out so as to generate and start a Widget icon 110 at the dragged position on the desktop 150 (step 245). Here, the started Widget icon 110 executes an operation according to the operation program data 173.

On the other hand, the control device 108 monitors whether the Widget icon 110 is deleted (step 347). In the embodiment, a delete button 112 is arranged on the upper right of the Widget icon 110. When a delete operation is performed with this delete button 112, the control device 108 deletes the Widget icon (110) from the desktop 150 to stop the start (step 353) and further deletes the flag of the deleted Widget icon 110 (step 355). Moreover, when the user terminal 110 is terminated without operating the delete button 112 (step 349), the control device 108 stores the image of the desktop 150 (step 351) and terminates the process.

Next, referring to FIG. 8, explanation will be given on start of the Widget system based on the start principle of the user terminal 100. In FIG. 8, when power of the user terminal 100 is turned ON, the control device 108 sets up the Window system OS (step 361) and performs authentication (step 363). Here, since the user authentication is set as a personal computer by the user, if the user does not perform setting, the user need not authentication. When the user authentication is complete, a screen for inputting a user number and a password (not depicted) appears and the Widget system is authenticated (step 365). When the authentication is complete, the control device 108 generates and displays the desktop 150 showing the Widget menu region 120 as shown in FIG. 9 (step 367). Next, the control device 108 calls in the Widget operation program data 176 according to the start icon stored in the startup and starts the Widget system (step 369). The control device 108 judges which menu icon 130 has a flag and sets the Widget icon 110 associated with the menu icon 130 having a flag, if any, to the operation state (step 371).

Next, referring to FIG. 9, explanation will be given on the desktop 150 of the user terminal 100 into which the Widget system has been introduced. In FIG. 9 in this embodiment, the Widget menu region 120 is set in a belt shape prolonged in the vertical direction and arranged at one side of the desktop 150. The Widget menu region 120 may be deformed by dragging its side or corner portion. In the Widget menu region 120, combinations of names and icons as pairs are arranged as menu icons 130. In this Widget menu region 120, the user can visually recognize which Widget is downloaded.

By dragging the menu icon 130 from the Widget menu region 120 to the desktop 150, it is possible to display and start the Widget icon 110. Moreover, by deleting the Widget icon 110 via the delete button 112, it is possible to use a large area of the desktop. Thus, in this embodiment, it is possible to use the desktop as a bulletin board of information or delete the information when not required so as to use a large area of the desktop.

Here, explanation will be given on some the Widgets used in this embodiment. Firstly, as has been described above, the Widgets icons 110 in this embodiment can be largely divided into view Widgets 110a and transaction Widgets 110b.

The view Widgets 11a may be a passbook Widget 110aa, an investment trust Widget 110ab, market information 110ac, a balance meter 110ad, a community Widget 110ae, a bank channel 110af, and the like. The passbook Widget 110aa displays a balance and a transaction detail. If registered, it is possible to view the family's passbook and moneybox Widget balance. The investment trust Widget 110ab displays information on a standard price of the purchased investment trust and also can collect associated news from Web and display it. The market information 110ac displays domestic and overseas market information in real time. The balance meter 110ad can set a saving target and indicate a plus/minus balance of the account balance by a needle. The community Widget 110ae can be used to participate in an interesting community from the community portal page of a bank HP, to display an utterance in the community chat (or Twitter), and to input an utterance into the Widget. The bank channel 110af is used to display a dynamic image distributed from a banking institution or other financial information providing company and automatically narrow the associated dynamic image by using a keyword of the purchased stock, the investment trust type, and the like.

On the other hand, the transaction Widgets 110b may be a moneybag 110ba, a moneybox 110bb, public utility charges payment 110bc, and the like. Moreover, on a stock block transaction 110bd, both of view and transaction can be performed. The moneybag 110ba is used for an actual money transaction by drag and drop of a bill icon and the balance can be linked with the passbook Widget. As for the moneybox 110bb, it is possible to set a target of saving so as to gradually save money like secret money. It is possible to drag and drop money from the moneybag Widget. It is also possible to establish a difficult mechanism to destroy the moneybox before reaching the target so as to forcibly save the money. When a monthly date of the public utility charges payment 110bc approaches, the icon is lit so that the user can know it. The user can drag and drop money from the moneybag Widget for payment. The stock block transaction 110bd is used to register a held stock and the user can view the price transaction in real time. The minus transition is displayed in the red color while the plus transition is displayed in the blue color. A large transition is displayed in a large expression. The user can drag and drop money from the moneybag to increase the stock.

Next, referring to FIG. 10, explanation will be given on a basic operation flow of the view Widget 110a. The control device 108 executes a predetermined dynamic image operation of the Widget icon 110 according to the operation program 173 of the Widget icon 110 (step 381). The control device 108 judges whether a predetermined time has elapsed. When the predetermined time has elapsed (step 383), the control device 108 requests the integral management program to collect information (step 385). According to the program of the operation program 176, the control device judges whether the information collection request requires authentication (step 389). If no authentication is required, the information request is sent to the information providing company 70 (step 395). In this embodiment, a judgment condition is provided for each of the Widget data 171 and the step 389 is judged according to the corresponding judgment condition.

On the other hand, when authentication is required, an authentication request window (not depicted) is displayed adjacent to the Widget data 171 (step 391). If the authentication is successful (step 393), the information request is made to the information providing company 70 (step 393). Upon reception of the information provided by the information providing company (step 398), the control device 108 generates and stores history information (step 397) and provides the received information to the Widget data 171 (step 397). The Widget data 171 updates the content displayed in the information display unit 111 according to the provided information (step 387).

Next, referring to FIG. 11 and FIG. 12, explanation will be given on the operation flow of the transaction Widget 110b. Here, explanation will be given on a specific example shown in FIG. 12, i.e., money is put into the moneybox Widget 110bb by a drag operation from the moneybag Widget 110ba.

In FIG. 11 of thus embodiment, a transaction operation is executed by the dragged transaction Widget 110b as a main body. That is, the control device 108 operated by the operation program of the moneybox Widget 110bb judges whether information has been received according to a drag in accordance with the operation program of the transaction Widget 110b (moneybox Widget 110bb). If drag information is present, it is judged whether the information can be received according a judgment condition stored in the operation program 173 in advance.

For example, in the case of moneybox Widget 110bb, information on the amount of money is received while any other information than the amount of money which is dragged is rejected (step 416). On the other hand, if the information can be received, a linkage request with the transaction Widget 110b (moneybag 110ba) of the partner is requested to the integral management program 170 (step 405). The integral management program 170 instructs the moneybag Widget 110ba which is the partner Widget to modify temporary display (step 421), sends a temporary permission report of the linkage display to the moneybox Widget 110bb (step 423), and displays an authentication request window 113 in the vicinity of the moneybox Widget 110bb on the desktop 150 (step 435).

On the other hand, upon reception of the linkage display temporary permission report, the transaction Widget 110b temporarily modifies the display based on the drag (step 407). It is monitored whether a predetermined time has elapsed (step 409). When the predetermined time has elapsed, an alarm display is performed (step 411). It is further monitored whether a predetermined time has elapsed (step 413). When the predetermined time has elapsed, a stop signal of the temporary display by the drag is sent to the integral management program 170 (step 415). That is, in this embodiment, is a drag operation is performed within a predetermined time, the operation is can modify the display content of the transaction Widget 110b of the receiver and the partner as a temporary display. However, the display content is also cancelled unless an authentication procedure is performed within a predetermined time. That is, upon reception of the temporary display stop signal, the integral management program 170 issues a temporary display stop instruction to the transaction Widget 110b of the partner (step 433) and issues a temporary display stop instruction of the linkage display to the transaction Widget 110b of the receiver (step 435) so as to generate history information (step 437). On the other hand, the transaction Widget 110b of the partner also stops temporary display so as to restore the state before the drag (step 417).

The integral management program 170 monitors in step 435 whether a password is inputted into the authentication request window 113 (step 427). If yes, authentication is performed (step 429). If the authentication is successful, an update request of the dragged data is sent to the banking institution host server 20 (step 431). The banking institution host server 20 updates the data according to the request and reports the updated content to each Widget (step 440). Thus, according to the updated content, the display contents of transaction Widget 110b of the receiver and the partner are rewritten.

Next, referring to FIG. 13, explanation will be given on the operation flowchart when generating a Widget icon 110 according to another embodiment. In this embodiment, the control device 108 monitors whether a menu icon 130 is dragged from the Widget menu region 120 (step 451). If yes, a start icon of the Widget icon 110 corresponding to the menu icon 130 is generated upon start up of the user terminal 100 (step 453). The Widget icon 110 is generated on the desktop and started (step 455).

On the other hand, when delete of the Widget icon 110 is instructed (step 457), the Widget icon 110 is deleted from the desktop 150 and start is stopped (step 463) so as to delete the start icon 465 from the startup (step 465).

When delete of the Widget icon 110 is not instructed and the user terminal process is performed (step 459), the desktop is stored in the storage device (step 461) and start of the user terminal 100 is stopped.

In this embodiment, since the user terminal 100 terminates a process with the start icon of the Widget icon 110 stored in the startup, when the user terminal 100 is started again, the Widget icon 110 can be displayed in a started state on the desktop 150 upon startup like in the operation program stored in the normal startup.

As has been described above, according to the Widget system of the present embodiment, it is possible to acquire information from other information site via the network. When the information is displayed as a menu icon in the menu region displayed on the desktop, the operation is set to a stop state. When the menu icon is dragged from the menu region to the desktop, the Widget operates to display the information acquired via the network. In this case, the Widget is formed by an individual operation program set for each of the menu icons and an integral management program which integrally controls the individual operation programs. The individual operation program is formed by menu image data, image data on the menu region, the operation program data, authentication data including the user personal information, and partner address information from which information is to be acquired. The individual operation program is formed by image data on the Widget icon displayed on the desktop and the Widget icon operation program. Furthermore, the Widget receives by drag, information from other Widget for which the Widget is displayed on the desktop. If the information coincides with a preset condition, it is possible to modify the display content of the Widget information in the other Widget and the local Widget.

Accordingly, in this embodiment, it is possible to display a necessary Widget as an arbitrary menu on the desktop and display the Widget on the desktop from the menu by drag operation or delete it. Thus, it is possible to provide a service which can be customized according to a user's preference.

It should be further understood by those skilled in the art that although the foregoing description has been made on embodiments of the invention, the invention is not limited thereto and various changes and modifications may be made without departing from the spirit of the invention and the scope of the appended claims.

1. A method for providing information by a data processing device which can acquire information from other information providing site via a network, wherein
no operation of menu is performed in a state when displayed as a menu icon in a menu region on a desktop, and
operation of menu as the Widget for displaying information acquired via the network is performed in a state when the menu icon is dragged from the menu region to the desktop.

2. The method for providing information by a data processing device as claimed in claim 1, wherein
the Widget is formed by individual management programs each set for each of the menu icons and an integral management program for integrally controlling the individual operation programs.

3. The method for providing information by a data processing device as claimed in claim 2, wherein
the individual operation programs include menu image data, image data in the menu region, operation program data, authentication data containing user personal information, and partner address information for acquiring information, and
the integral management program includes Widget icon image data displayed on the desktop and an operation program of the Widget icon.

4. The method for providing information by a data processing device as claimed in claim 1, wherein
the Widget receives information from other Widget displayed on the same desktop where the local Widget is displayed, by a drag operation and modifies the information in the other Widget and the local Widget if the information coincides with a preset condition.

5. The method for providing information by a data processing device as claimed in claim 2, wherein
the Widget receives information from other Widget displayed on the same desktop where the local Widget is displayed, by a drag operation and modifies the information in the other Widget and the local Widget if the information coincides with a preset condition.

6. The method for providing information by a data processing device as claimed in claim 3, wherein
the Widget receives information from other Widget displayed on the same desktop where the local Widget is displayed, by a drag operation and modifies the information in the other Widget and the local Widget if the information coincides with a preset condition.
